(19) United States
(12) Patent Application Publication
(10) Pub. No.: US 2026/0017101 A1
(43) Pub. Date: Jan. 15, 2026

(54) UPDATING A RESOURCE WITH MODIFICATION ENABLING FRAMEWORK

(71) Applicant: DevRev, Inc., Palo Alto, CA (US)

(72) Inventors: Bojan Dimovski, Ljubljana (SI); Dario Gavranovic, Stara Cerkev (SI); Mladen Barjaktarevic, Ljubljana (SI); Tjaša Šinkovec, Ljubljana (SI)

(73) Assignee: DevRev, Inc., Palo Alto, CA (US)

(21) Appl. No.: 18/769,314

(22) Filed: Jul. 10, 2024

(51) Int. Cl. G06F 9/50

(52) U.S. Cl. CPC G06F 9/5027

(57) ABSTRACT

The present subject matter discloses techniques to efficiently update a resource. The resource is updated in response to changes in an operational status indicator associated with the resource. A first signal is received in response to change in the operational status indicator. Based on the operational status indicator, it is ascertained whether to trigger generation of a virtual instance of a modification enabling framework for generating a data file. Further, a second signal is received in response to subsequent change in the operational status indicator. Parsing of at least one of an executable content and a commit message from the data file is then triggered to generate an updated specification that provides an updated overview for the resource. Further, a resource updation signal is generated to associate the updated specification with the resource.

### BACKGROUND

Organizations often create and/or develop various services, for example, in the form of software products or applications and platforms. Such services are generally created, developed, and/or modified using various support and development tools and platforms. Entities, such as developers, may use such tools and perform various tasks associated with creation, development, and modification of such services. For example, the developers may perform various tasks, including programming or coding, using support and development tools or platforms for the development of such services.

### BRIEF DESCRIPTION OF FIGURES

The drawings illustrate the design and utility of various embodiments of the invention. It should be noted that the figures are not drawn to scale and that elements of similar structures or functions are represented by reference numerals throughout the figures. In order to better appreciate how to obtain the above-recited and other advantages and objects of various embodiments of the invention, a detailed description of the present subject matter will be rendered by reference to specific embodiments thereof, which are illustrated in the accompanying drawings. Understanding that these drawings depict only typical embodiments of the invention and are therefore not to be considered limiting of its scope, the present subject matter will be described and explained with additional specificity and detail through the use of the accompanying drawings.

FIGS. 1A and 1B illustrate a computing environment, in accordance with an example implementation of the present subject matter.

FIG. 2 illustrates a block diagram of a system, according to one example implementation of the present subject matter

FIG. 3 illustrates a block diagram of a computing environment including the system, according to another example implementation of the present subject matter.

FIG. 4 illustrates a method to update a resource, according to an example implementation of the present subject matter.

FIG. 5 illustrates a computing environment implementing a non-transitory computer-readable medium for generating recommendations by identifying linkable items, according to an example implementation of the present subject matter.

### DETAILED DESCRIPTION

Organizations create and develop a wide range of services. Examples of these services may include, but are not limited to, software products, applications, customer-oriented websites, e-commerce platforms, data storage services or platforms, and cloud-based platforms. To facilitate the development, modification, coding or programming platforms, and/or maintenance of such services, various support and development tools and platforms have been designed. Such tools enable developers to perform various tasks related to support, development, and modification of such services. In one example, the developers may interact with such tools to engage in development-related activities such as programming or coding for the development of such services. By leveraging such tools, the developers or developer-end entities may build, enhance, and maintain the services.

Generally, the developer-end entities have one or more tasks, for example, in the form of work assignments assigned to them. Examples of such work assignments may include, but are not limited to, enhancements proposals, bug reports, feature proposals, and notes indicating required feature modifications and updates. The developer-end entities may engage or utilize the support and development tools or platforms to perform development-related activities and advance towards completing the work assignments or work items. For example, a developer may access an assigned work item and access a support and development tool to engage in programming for modifying a software application or platform. Once the developer-end entities have worked on the work items, the developer-end entities may then have to perform administrative tasks, for example, create or update work logs to define the work they have performed or completed.

However, the developer-end entities have to switch between different tools or platforms in order to work on the work items. For example, the developer-end entities receive and access the work items over a first tool or platform. The first tool or platform, for example, may be associated with the services or may be a third-party tool or platform. Once the work items are received and accessed, the developer-end entities have to switch to another tool or platform, say a second tool or platform, having capabilities or features that allow them to engage in development-related activities, such as programming or coding, to complete the work assignments or work items. Further, after working on the work items, the developer-end entities either have to switch back to the first tool or platform, or to another tool or platform, to perform the administrative tasks. Considering a scenario where the developer-end entities have to work on multiple work items, the developer-end entities have to switch repeatedly between a plurality of tools and platforms.

Switching between a plurality of tools and platforms has several drawbacks and limitations. For example, when the developer-end entities have to switch between different tools or platforms frequently, there's an overhead associated with context switching. Context switching refers to the mental effort required to transition from working on one tool or platform to another and it can take a considerable amount of time to regain focus after switching between the tools or platforms. Thus, frequent switching reduces focus and disrupts the development workflow, thereby impacting the overall productivity. Additionally, switching between unrelated tasks can negatively impact the quality of work as the chances of errors increase due to unnecessary distractions caused due to frequent switching. As a result, inefficiencies are introduced in the development workflow and the output may be reduced.

Further, switching frequently between multiple tools or platforms negatively impacts resource consumption. For example, as each tool or platform consumes computing resources, such as memory, processing power, and network bandwidth, frequent switching increases resource usage, potentially slowing down the overall system. Additionally, repeated closing and relaunching of tools and platforms unnecessarily exerts processing loads on the resources, thereby affecting their processing capabilities, for example, processing speed. Also, since the resources may be busy handling repeated closing and relaunching of tools and platforms, the resources may have reduced capabilities to attend to other tasks or requests. Thus, the other tasks or requests are either rejected or throttled, thereby causing a delay in task or request processing. Thus, switching between multiple tools and/or platforms hinders productivity, workflow efficiency, and creates technical challenges.

The present subject matter discloses techniques for efficiently updating a resource. Examples of the resource may include, but are not limited to, an enhancements proposal, a bug report, a feature proposal, logs of work done, and notes indicating feature modifications and updates. In one example, the resource may be associated with a service. Examples of the service may include, but are not limited to, software products, applications, customer-oriented websites, e-commerce platforms, data storage services or platforms, and cloud-based platforms.

In one example, the resource may be created, defined, and/or submitted by the developer-end entities. The developer-end entities may be, for example, developers, engineers, or managers associated with the service. In another example, the resource may be, or may be derived from, tickets or issues that may be raised or submitted by one or more users interacting with the service. For example, the users may submit one or more tickets indicating a problem, bugs, or other requests in association with the service.

Further, in one example, the resource may have a specification associated therewith. The specification, in one example, may provide an overview about the resource. For instance, the specification may include at least one of a title and a description providing an overview of the resource. The resource may also have, in one example, an operational status indicator, associated therewith, for indicating whether the resource is engaged with a modification enabling framework. The modification enabling framework may be any tool or platform that may be used for, or may at least assist in, performing development and/or support-related activities. Thus, the operational status indicator may indicate whether the resource is engaged with the modification enabling framework, i.e., undergoing any development and/or support-related activity.

According to one example of the present subject matter, a first graphical interface may be rendered and may indicate the resource and the operational status indicator associated with the resource. Further, in one example, the first graphical interface may enable the developer-end entity change the operational status indicator. The developer-end entity, for instance, may change the operational status indicator to indicate whether the resource is engaged with the modification enabling framework. Changing the operational status indicator may trigger generation of a first signal.

In one example, upon occurrence of a change in the operational status indicator associated with the resource, the first signal may be received. The operational status indicator may be changed, for example, to indicate that the resource is either engaged, or is to be engaged, with the modification enabling framework. Based on the operational status indicator, it may be ascertained whether generation of a virtual instance of the modification enabling framework is to be triggered. Generation of the virtual instance may be, for example, creation of a session, branch, or an extension of the modification enabling framework. The virtual instance, in one example, may be a graphical interface enabling the developer-end entities to perform development and/or support-related activities.

Further, in one example, generation of the virtual instance may create a data file. The data file may record or save data related to the development and/or support-related activities performed by the developer-end entities while utilizing, engaging, and/or interacting with the virtual instance. In one example, the data file may include at least one of an executable content and a commit message. The executable content, in one example, may be a set of programs written or coded by the developer-end entities while performing the development and/or support-related activities by utilizing, engaging, and/or interacting with the virtual instance. Further, the commit message, for example, may be comments, tags, or other non-executable descriptors that may be added by the developer-end entities while performing the development and/or support-related activities.

Further, upon occurrence of a subsequent change in the operational status indicator, a second signal may be received. The subsequent change in the operational status indicator may be to indicate, in one example, that creation of the data file has been at least partially completed. For example, when the development and/or support-related activities, and thus the data file, has been at least partially completed, the operational status indicator may be changed. In one example, the operational status indicator may be changed by the developer-end entities. In another example, the operational status indicator may be changed automatically. For example, the operational status indicator may be changed automatically upon completion of a pre-defined time period. Thus, subsequent change of the operational status indicator may trigger generation of the second signal.

In response to receiving the second signal, parsing of at least one of the executable content and the commit message of the data file may be triggered. Subsequently, generation of an updated specification may be triggered. The updated specification may be generated for being associated with the resource. The updated specification may provide an updated overview of the resource based on at least one of the executable content and the commit message of the data file. That is, the updated specification may provide an updated overview of the resource based on the data file that records the development and/or support-related activities performed by the developer-end entities using the virtual instance. In one example, an advanced learning model may be triggered for parsing the executable content and the commit message of the data file and generating the updated specification. The advanced learning model may be a large language model or may be capable of performing natural language processing (NLP). Therefore, the advanced learning model may analyze and process at least one of the executable content and the commit message of the data file and accordingly generate the updated overview based on the work done by the developer-end entities. The updated specification may include, for example, at least one of an updated title and an updated description for the resource based on the performed development and/or support-related activities. A resource updation signal may then be generated to associate the updated specification with the resource, thereby updating the resource.

The present subject matter addresses the problems associated with the conventional techniques that included frequent switching between a plurality of tools and platforms and required manual performance of administrative tasks. For example, when the operational status indicator is changed to indicate that the resource is engaged with the modification enabling workflow, generation of the virtual instance is automatically triggered. Since the virtual instance, which may be an extension or a branch of the modification enabling workflow, is generated, the developer-end entities may no longer have to switch to another tool or platform, from the tool or platform on which they came across the resource, to perform the development and/or support-related activities. For example, instead of switching to the modification enabling workflow, a virtual instance of the modification enabling workflow itself is generated automatically upon detecting that the resource is engaged, or is going to be engaged, with the modification enabling framework. Therefore, since the virtual instance is generated, switching to the modification enabling framework may no longer be necessary. Thus, switching between the plurality of tools and platforms may be significantly reduced.

Further, by reducing the requirement to switch between the plurality of tools and platforms, the mental effort required to transition from working on one tool or platform to another is significantly reduced. The development and/or support-related activities may thus be performed with improved focus, reduced errors, and without disrupting the development workflow. Further, since the updated specification is automatically generated by parsing the contents of the data file, the administrative tasks required to be performed by the developer-end entities may be reduced. The developer-end entities may now have more bandwidth to perform the development and/or support-related activities. The developer-end entities may thus have more time to invest in development and/or support-related activities rather than being involved in administrative tasks. The overall productivity and quality of work may thus be enhanced.

Further, resource consumption may be considerably reduced. For example, since unnecessary and repeated closing and relaunching of tools and platforms may not be required, reduced processing loads may be experienced by the resources. The processing capabilities, for example, the processing speed may thus be improved as the resources have reduced processing load. Additionally, the resources may now have the bandwidth to attend to other tasks or requests. Thus, rejections and/or delays that may be experienced by the other tasks or requests may be reduced. Thus, the resources may be updated without, or at least with reduced number of, switching between multiple tools and/or platforms, thereby improving productivity, workflow efficiency, and resource conservation.

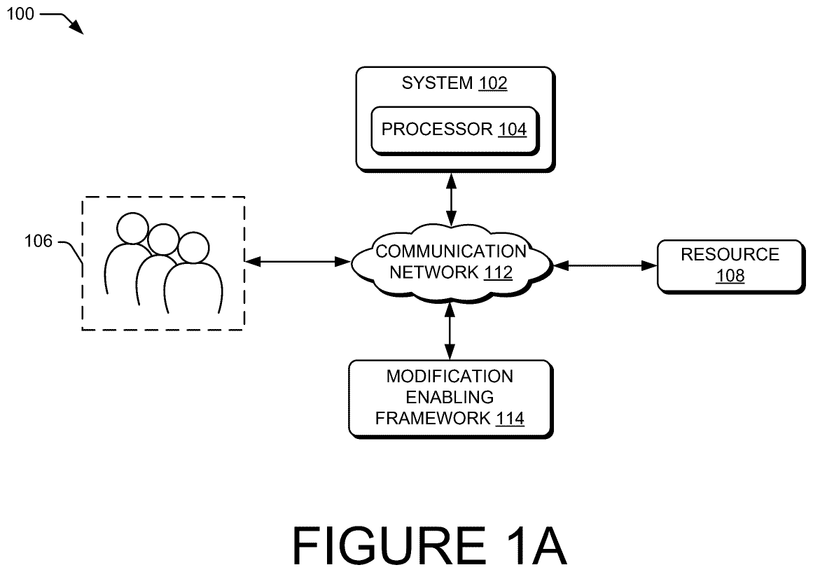

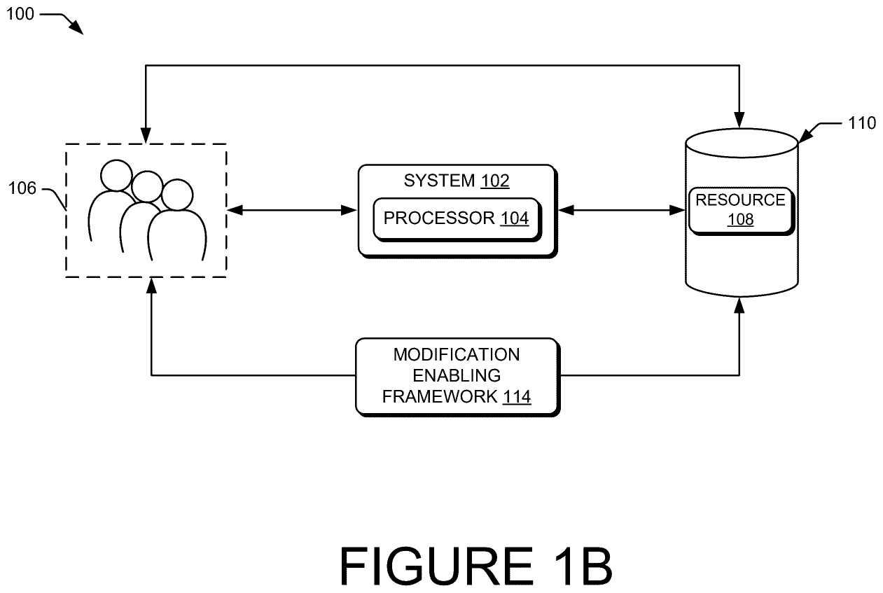

The present subject matter is further described with reference to FIGS. 1A-5 It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIGS. 1A and 1B illustrate a computing environment 100, in accordance with an example implementation of the present subject matter. For the sake of brevity, FIGS. 1A and 1B may be discussed in conjunction with each other. In one example, the computing environment 100 may include a system 102 having a processor 104. The computing environment 100 may further include one or more developer-end entities 106, and a resource 108. In one example, the computing environment 100 may also include a data repository 110.

Further, the system 102, the one or more developer-end entities 106, and the resource 108 may be communicably coupled in the computing environment 100. In one example, the system 102, the one or more developer-end entities 106, and the resource 108 may be communicably coupled via a communication network 112, as illustrated in FIG. 1A, to exchange data, files, and/or signals therebetween. The communication network 112 may be a wireless network, a wired network, or a combination thereof. The communication network 112 may also be an individual network or a collection of many such individual networks, interconnected with each other and functioning as a single large network, for example, the Internet or an intranet. Examples of such individual networks include local area network (LAN), wide area network (WAN), the internet, Global System for Mobile Communications (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 112 may include various network entities, such as transceivers, gateways, and routers. In an example, the communication network 112 may include any communication network that uses any of the commonly used protocols, for example, Hypertext Transfer Protocol (HTTP), and Transmission Control Protocol/Internet Protocol (TCP/IP). In another example, the system 102, the one or more developer-end entities 106, and the resource 108 may be in direct communication with each other, as illustrated in FIG. 1B, to exchange data, files, and/or signals therebetween.

In one example, the computing environment 100 may be related to any coding/programming-related activity where one or more users may write, run, and/or modify any computer program. In another example, the computing environment 100 may be related to maintenance, development, and/or support-related activities that are performed for one or more services. For example, the computing environment 100 may be related to the development or modification of a software-based product or platform.

In one example, the computing environment 100 may include the one or more developer-end entities 106. In one example, the one or more developer-end entities 106 may be entities that may perform activities related to maintenance, development, modification, and enhancement of various services being offered. Examples of the one or more developer-end entities 106 may include, but are not limited to, product managers, tech leads, developers, engineers, and a solution expert. In one example, the one or more developer-end entities 106 can also be a user that may perform activities related to maintenance, development, modification, and enhancement of various services being offered. Other examples of the one or more developer-end entities 106 may include, but are not limited to, a trained logical model, a robot, or any other entity that may be capable of, or configurable, to perform activities related to maintenance, development, modification, and enhancement of various services being offered.

Further, examples of the service may include, but are not limited to, a software product or an application, customer-oriented website, e-commerce platform, data storage service or platform, a query or search engine, and cloud-based platform. In one example, the service may also be a software-based product or application that may still be under development or testing phase. The one or more developer-end entities 106 may perform various maintenance, development, and/or support-related activities or tasks for the services. For example, the one or more developer-end entities 106 perform programming for maintenance, development, or modification of the service.

The computing environment 100 may also include one or more resources, such as the resource 108. In one example, the resource 108 may be associated with the service. For example, the resource may be a set of program/code associated with the service. Other examples of the resource 108 may include, but are not limited to, an enhancement proposal, a bug report, a feature proposal, a log of work done, and notes indicating feature modifications and updates related to the service. In one example, the resource 108 may be created, defined, and/or submitted by the one or more developer-end entities 106. In another example, the resource 108 may be, or may be derived from, tickets or issues that may be raised or submitted by one or more users interacting with the service. For example, the users may submit one or more tickets indicating a problem, bugs, or other requests in association with the service. In one example, the resource 108 may be stored in the data repository 110, as illustrated in FIG. 1B. The resource 108 may be accessible, in one example, directly by the one or more developer-end entities 106 and/or the system 102. In another example, the resource 108 may be accessible through the data repository 110. The data repository 110 may be any repository or storage unit implemented by physical, logical, and/or virtual storage devices configured to store the resource 108.

In another example, the resource 108 may be a computing resource. For example, the resource may be a Central Processing Unit (CPU), a memory, a Graphics Processing Unit (GPU), a server, an access point, a Tensor Processing Unit (TPU), a Field-Programmable Gate Array (FPGA), a system on chip (SOC), Application-Specific Integrated Circuit (ASIC). The service may be implemented over the computing resources. In yet another example, the resource 108 may itself be the service. For example, the resource 108 may be a software product or an application. Though a single resource 108 has been illustrated, multiple similar resources may also be a part of the computing environment 100 and may be communicably coupled with the system 102.

Further, in one example, the resource 108 may have associated therewith a specification and an operational status indicator. The specification, in one example, may provide an overview about the resource 108. The specification may include, in an example, at least one of a title and a description that may provide the overview of the resource 108. For example, in case the resource 108 is an enhancement proposal, the specification may include at least one of the title and the description indicating that the resource 108 is related to some enhancements/modifications that are required to be made to the service. In another example, if the resource 108 is the computing resource, the specification may provide an overview of the computing resource. For example, the specification may include at least one of a title and a description providing, or indicating, details about specifications, features, operating parameters, a set of programs, source code, or settings of the computing resource. In yet another example, if the resource 108 is the service itself, the specification may include at least one of a title and a description providing details about specifications, a source code, settings, functioning, or features associated with the service. The specification may also include, in one example, an identification information that may uniquely identify each resource, such as the resource 108, of the computing environment 100. The identification information, in one example, may be a unique ID associated with each resource of the computing environment 100. In one example, the resource 108 may also be formed by a combination of resources.

Further, the operational status indicator, associated with the resource 108, may indicate whether the resource 108 is engaged with a modification enabling framework 114. In one example, the computing environment 100 may include the modification enabling framework 114 that may be any device, tool, or platform that may be used by, or may at least assist, the one or more developer-end entities 106 in performing maintenance, development, and/or support-related activities for the service. For example, the modification enabling framework 114 may be a coding platform where the one or more developer-end entities 106 may be allowed to engage in programming, or programming-related, activities. In one example, the modification enabling framework 114 may allow the one or more developer-end entities 106 to modify the resource 108, or the specification associated with the resource 108. For example, the modification enabling framework 114 may enable the one or more developer-end entities 106 to create or modify a source code (for example, that may be a part of the specification) associated with the resource 108 for performing maintenance, development, and/or support-related activities. In another example, the modification enabling framework 114 may enable the one or more developer-end entities 106 to modify operating parameters or settings (for example, that may be a part of the specification) of the resource 108 for performing maintenance, development, and/or support-related activities.

The operational status indicator may thus indicate whether the resource 108 is engaged with the modification enabling framework 114, i.e., undergoing any maintenance, development, and/or support-related activity. In one example, the operational status indicator may provide a textual indication for indicating whether the resource 108 is engaged with the modification enabling framework 114. For example, the operational status indicator may indicate “In development” to indicate that the resource 108 is engaged with the modification enabling framework 114. Further, the operational status indicator may indicate another textual indication for indicating that the resource 108 is no longer, or not, engaged with the modification enabling framework 114. For example, the operational status indicator may indicate “In review” to indicate that the resource 108 is no longer engaged with the modification enabling framework 114.

In another example, the operational status indicator may provide a visual indication. The visual indication may be, in one example, a color-coded indication where different colors may indicate a different message. For example, if the operational status indicator indicates a red colored indication, the operational status indicator may be considered to be indicating that the resource 108 may be engaged with the modification enabling framework 114. However, if the operational status indicator indicates a green colored indication, the operational status indicator may be considered to be indicating that the resource 108 may no longer be engaged with the modification enabling framework 114. Similarly, any color, or a combination thereof, may be used to indicate status of engagement of the resource 108 with the modification enabling framework 114. Further, in one example, the specification and the operational status indicator may be stored in the data repository 110.

The computing environment 100 may further include the system 102. In one example, the system 102 may be communicably coupled with the one or more developer-end entities 106, the resource 108, the data repository 110, the communication network 112, and the modification enabling framework 114. The one or more developer-end entities 106 may access the resource 108 and/or the modification enabling framework 114 via the system 102. In one example, the system 102 may facilitate the creation or establishment of an interface between the one or more developer-end entities 106, the resource 108, and the modification enabling framework 114. The system 102, in one example, may enable, or at least assist or facilitate, in efficiently updating or modification of the resource 108. In one example, updating or modification of the resource 108 may be performed by updating at least one of the specification and the operational status indicator associated with the resource 108, as will be discussed. In one example, the update or modification may be based on, or a result of, maintenance, development, and/or support-related activities performed by the one or more developer-end entities 106.

Further, the system 102 may include the processor 104. Examples of the processor 104 may include, but are not limited to, microprocessors, microcomputers, microcontrollers, digital signal processors, central processing units, state machines, logic circuitries, Artificial Intelligence (AI) based processors, processing circuitries including one or more modules or engines, and/or any other devices that receive and manipulate signals and data based on computer-readable instructions. In other examples, the processor 104 may be an intangible entity. For example, the processor 104 may be any virtual or software-based entity having capabilities to receive and manipulate signals and data based on computer-readable instructions. For example, the processor 104 may be, or may have deployed therein, a trained logical model, an advanced learning model, a neural network, a deep learning network, and a large language model (LLM). Further, though not illustrated, the system 102 may include, in one example, the resource 108, the data repository 110, the communication network 112, and the modification enabling framework 114.

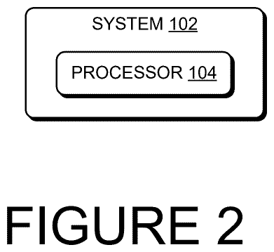

FIG. 2 illustrates a block diagram of the system 102, according to one example implementation of the present subject matter. FIG. 2 will be discussed in conjunction with FIGS. 1A and 1B.

The system 102, in one example, may enable, or at least assist or facilitate, in efficiently updating or modification of the resource 108. In one example, updating or modification of the resource 108 may be performed by updating the specification associated with the resource 108. In one example, the update or modification may be based on, or a result of, maintenance, development, and/or support-related activities performed by the one or more developer-end entities 106.

In one example operation, the processor 104 may receive a first signal. The first signal may be received by the processor 104 upon occurrence of a change in the operational status indicator associated with the resource 108. The operational status indicator may be changed, in one example, to indicate that the resource 108 is either engaged, or is to be engaged, with the modification enabling framework 114.

Based on the operational status indicator, the processor 104 may ascertain whether generation of a virtual instance of the modification enabling framework 114 is to be triggered. For example, if the processor 104 ascertains that the operational status indicator indicates that the resource 108 is to be engaged with the modification enabling framework 114, the processor 104 may trigger the generation of the virtual instance of the modification enabling framework 114. Generation of the virtual instance may be, for example, creation of a session, branch, or an extension of the modification enabling framework 114. The virtual instance, in one example, may be an interactive graphical interface enabling, or assisting, the one or more developer-end entities 106 to perform maintenance, development, and/or support-related activities with respect to the resource 108.

Further, in one example, generation of the virtual instance may cause creation of a data file. The data file may record or save data related to the maintenance, development, and/or support-related activities performed by the one or more developer-end entities 106 while utilizing, engaging, and/or interacting with the virtual instance. In one example, the data file may include at least one of an executable content and a commit message. The executable content, in one example, may be a code written by the one or more developer-end entities 106 while performing the maintenance, development, and/or support-related activities by utilizing, engaging, and/or interacting with the virtual instance. Further, the commit message, for example, may be comments, tags, or other non-executable descriptors that may be added by the one or more developer-end entities 106 while performing the maintenance, development, and/or support-related activities.

one or more developer-end entities 106 Further, the processor 104 may receive a second signal. In one example, the second signal may be received upon occurrence of a subsequent change in the operational status indicator. The subsequent change in the operational status indicator may be to indicate, in one example, that creation of the data file has been at least partially completed. For example, when the maintenance, development, and/or support-related activities, and thereby the data file, has been at least partially completed, the operational status indicator may be changed. In one example, the operational status indicator may be changed by the developer-end entities.

In response to receiving the second signal, the processor 104 may trigger parsing of at least one of the executable content and the commit message of the data file. Subsequently, the processor 104 may trigger generation of an updated specification. The updated specification may be generated for being associated with the resource 108. The updated specification may provide an updated overview of the resource 108 based on at least one of the executable content and the commit message of the data file. That is, the updated specification may provide an updated overview of the resource based on the data file that recorded the maintenance, development, and/or support-related activities performed by the one or more developer-end entities 106 by accessing the virtual instance. In one example, the processor 104 may trigger an advanced learning model for parsing the executable content and the commit message of the data file and generating the updated specification. The advanced learning model may be a large language model or may be capable of performing natural language processing (NLP). Therefore, the advanced learning model may analyze and process at least one of the executable content and the commit message of the data file and accordingly generate the updated specification or overview based on the activities of the one or more developer-end entities 106. In one example, the updated specification may include at least one of an updated title and an updated description for the resource 108 based on the performed maintenance, development, and/or support-related activities performed by the developer-end entities. Once the updated specification has been generated, the processor 104 may generate a resource updation signal to associate the updated specification with the resource 108, thereby updating the resource 108.

The system 102 may reduce the number of required switching operations between a plurality of tools and platforms. The system 102 may also eliminate, or at least reduce, the requirement manual administrative tasks. For example, when the operational status indicator is changed to indicate that the resource is engaged with the modification enabling workflow, generation of the virtual instance is automatically triggered by the processor 104. Since the virtual instance, which may be an extension or a branch of the modification enabling framework 114, is generated, the one or more developer-end entities 106 may no longer have to switch to another tool or platform, from the tool or platform on which they came across the resource 108, to perform the maintenance, development, and/or support-related activities. For example, instead of switching to the modification enabling framework 114, a virtual instance of the modification enabling framework 114 itself may be generated automatically upon detecting that the resource 108 is to be engaged with the modification enabling framework 114. Therefore, since the virtual instance is generated, switching to the modification enabling framework 114 may no longer be necessary. Thus, switching between the plurality of tools and platforms may be significantly reduced. Further, resource consumption may be considerably reduced. For example, since repeated closing and relaunching of tools and platforms may not be required, reduced processing loads may be experienced by the resources. Thus, the resource 108 may be updated without, or at least with reduced number of, switching between multiple tools and/or platforms, thereby improving productivity, workflow efficiency, and resource conservation.

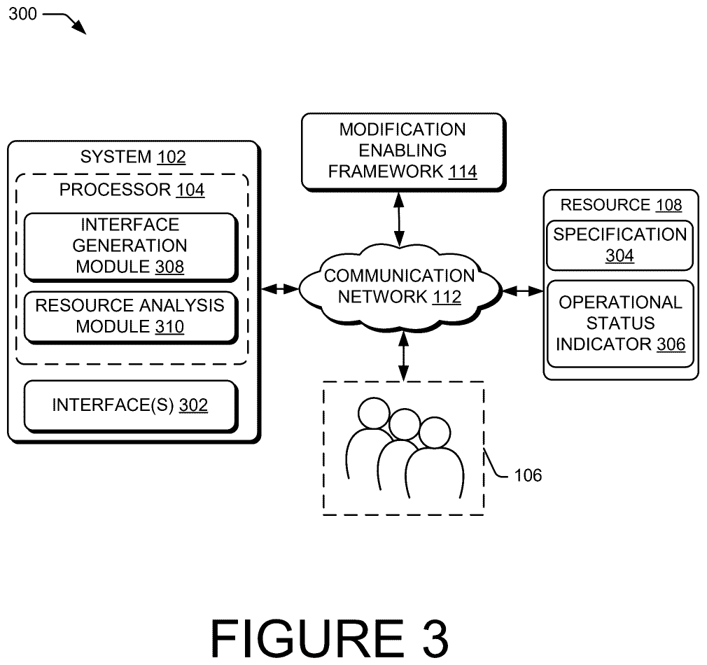

FIG. 3 illustrates a block diagram of a computing environment 300 including the system 102, according to another example implementation of the present subject matter. FIG. 3 will be discussed, and is to be considered, in conjunction with at least FIGS. 1A and 1B.

In one example, the computing environment 300 may be similar to the computing environment 100. In one example, the computing environment 300 may be related to maintenance, development, and/or support-related activities that are performed for one or more services. The computing environment 300 may include, in one example, the system 102, the one or more developer-end entities 106, the resource 108, and the modification enabling framework 114. In one example the system 102, the one or more developer-end entities 106, the resource 108, and the modification enabling framework 114 may be communicably coupled through the communication network 112.

As discussed above in reference to FIGS. 1A and 1B, the computing environment 300 may include the one or more developer-end entities 106 that may perform activities related to maintenance, development, modification, and enhancement in relation to the service(s) being offered, for example, to customers. In addition to the examples of the one or more developer-end entities 106 discussed above, the one or more developer-end entities 106 may also be computing devices. The computing devices may be configured to perform maintenance, development, and/or support-related activities automatically, based on the resources 108. In another example, the one or more developer-end entities 106 may be computing devices associated with one or more developers.

Further, as discussed above in reference to FIGS. 1A and 1B, the computing environment 300 may include the resource 108. The resource 108 may be accessible, in one example, directly by the one or more developer-end entities 106 and the system 102. In another example, the resource 108 may be accessible through the communication network 112. In another example, the resource 108 may be stored in the data repository 110 and may be accessed from the data repository 110. Examples of the resource 108 have been discussed above with reference to FIGS. 1A and 1B, however, other examples in a similar manner may also be possible.

Furthermore, as discussed above, the resource 108 may have associated therewith a specification 304 and an operational status indicator 306. The specification 304 and the operational status indicator 306 may be similar to the specification and the operational status indicator, respectively, as discussed above in reference to FIGS. 1A and 1B.

Further, as discussed above in reference to FIGS. 1A and 1B, the modification enabling framework 114 that may be any device, tool, or platform that may be used by, or may at least assist, the one or more developer-end entities 106 in performing maintenance, development, and/or support-related activities for the service. For example, the modification enabling framework 114 may be a coding platform where the one or more developer-end entities 106 may engage in programming, or programming-related, activities. In one example, the modification enabling framework 114 may allow the one or more developer-end entities 106 to modify the specification associated with the resource 108. For example, the modification enabling framework 114 may enable the one or more developer-end entities 106 to create or modify a script (for example, that may be the specification 304, or a part of the specification 304) associated with the resource 108 for performing maintenance, development, and/or support-related activities for the resource 108. In another example, the modification enabling framework 114 may enable the one or more developer-end entities 106 to modify one or more operational parameters (for example, that may be the specification 304, or a part of the specification 304) associated with the resource 108 while/for performing maintenance, development, and/or support-related activities.

Further, the system 102 may include the processor 104, as discussed above. In one example, the system 102 may also include interface(s) 302. The interface(s) 302 may allow communicably coupling the system 102, and/or the processor 104, with one or more other entities, such as the one or more developer-end entities 106, the resource 108, the modification enabling framework 114, the communication network 112, and the data repository 110. The connection or coupling may be through a wired connection or a wireless connection. Further, though not illustrated, the system 102, in one example, may also include a power supply unit. The power supply unit may, for example, manage distribution or supply of electrical current within the system 102 for functioning of the system 102.

In one example, the system 102 may facilitate establishment of an interface between the one or more developer-end entities 106, the resource 108, and the modification enabling framework 114. The system 102, in one example, may assist in efficiently updating the resource 108. In one example, updating or modification of the resource 108 may be performed by updating at least one of the specification 304 and the operational status indicator 306 associated with the resource 108. In one example, the update or modification may be based on, or a result of, maintenance, development, and/or support-related activities performed by the one or more developer-end entities 106.

In one example operation, a first graphical interface (not shown) may be rendered by the processor 104, or an interface generation module 308 of the processor 104. The first graphical interface, in one example, may be a Graphical User Interface (GUI) and may be accessible by the one or more developer-end entities 106. In one example, the system 102 may be located within a computing device associated with the one or more developer-end entities 106, and the processor 104 may trigger or cause rendering of the first graphical interface on the computing device. In another example, the first graphical interface may be rendered by the processor 104 as a webpage that may be accessible by the one or more developer-end entities 106 through the communication network 112. In yet another example, the system 102 may be remotely hosted and the processor 104 may render the first graphical interface in such a manner that it may be accessible to the developer end entities. For example, the system 102 may be a cloud-based system and may be accessible to the one or more developer-end entities 106.

In one example, the first graphical interface may indicate at least one of the resource 108, the specification 304 associated with the resource 108, and the operational status indicator 306 associated with the resource 108. In one example, the first graphical interface may also indicate at least one of the operational status indicator 306 associated with the resource 108, an actionable component allowing to change the operational status indicator 306 associated with the resource 108, and an interactive component enabling submission of the changed operational status indicator 306. In one example, the actionable component may allow selection of an operational status indicator from amongst a plurality of operational status indicators. For example, the actionable component may be a menu indicating the plurality of operational status indicators in association with the resource 108. The plurality of operational status indicators may be, for example, “In development” and “In review”, as discussed above. The plurality of operational status indicators may be, in another example, color-coded, such as red and green, as discussed above. In one example, the one or more developer-end entities 106 may interact with the actionable component to select and/or change the operation status indicator 306 associated with the resource 108. Further, the interactive component may allow submission of the changed operation status indicator 306. The interactive component may be, in one example, a submit button with which the one or more developer-end entities 106 may interact to submit the operation status indicator 306 or changed operation status indicator 306 for the resource 108.

Further, the first graphical interface may be, for example, a REACT-based interface. The first graphical interface may be built, for example, with REACT Javascript. REACT may provide the ability to detect interactions occurring with the first graphical interface or elements associated therewith. In this example, the elements associated with the first graphical interface may be the actionable component and the interactive component. Since the first graphical interface may be the REACT-based interface, the first graphical interface may event handlers, for example, on-Click and on-Submit that may be attached to the first graphical interface or the elements associated therewith. Upon interaction, the event handlers may be triggered and appropriate actions may then be initiated based on the interaction. The appropriate actions may be, for example, generation of signals indicating the interactions with the first graphical interface or the elements associated therewith.

Thus, when the operational status indicator 306 may be changed, for example to “In development”, the first signal may be generated by the first graphical interface. For example, submission of the changed operational status indicator 306 through the interactive component may cause generation and transmission of the first signal to the processor 104.

The processor 104 of the system 102 may receive the first signal. The first signal may be received by a resource analysis module 310 of the processor 104 upon occurrence of a change in the operational status indicator associated with the resource 108. The operational status indicator 306 may be changed, in one example, to indicate that the resource 108 is to be engaged with the modification enabling framework 114. For example, using the actionable component, the developer-end entity may select “In development” as the operational status indicator 306.

Based on the operational status indicator, the processor 104, or the resource analysis module 310, may ascertain whether generation of a virtual instance of the modification enabling framework 114 is to be triggered. For example, if the processor 104, or the resource analysis module 310 of the processor 104 ascertains that the operational status indicator 306 indicates “In development”, the processor 104 may ascertain that the resource 108 is to be engaged with the modification enabling framework 114. Similarly, if the processor 104, or the resource analysis module 310 of the processor 104, ascertains that the operational status indicator 306 indicates red color, the processor 104 may ascertain that the resource 108 is to be engaged with the modification enabling framework 114.

The processor 104, or the resource analysis module 310 of the processor 104, may then trigger the generation of the virtual instance of the modification enabling framework 114. Generation of the virtual instance may be, for example, creation of a session, branch, or an extension of the modification enabling framework 114. The virtual instance may include all, or selected, features of the modification enabling framework 114 that may be necessary for modification, development, and/or support-related activities. The virtual instance, in one example, may be an interactive graphical interface that may allow the one or more developer-end entities 106 to perform modification, development, and/or support-related activities for the resource 108 for which the operational status indicator was changed. For example, the virtual instance may be similar to the modification enabling framework 114. In another example, the virtual instance may be a branch of the modification enabling framework and may thus be a contained area in which the one or more developer-end entities 106 may perform modification, development, and/or support-related activities for the resource 108. In another example, the virtual instance may be a new/separate version of the modification enabling framework 114.

In addition to the example of the modification enabling framework 114, the modification enabling framework 114 may also include a repository. The repository may be, in one example, the data repository 110 that may store the resource 108, the specification 304 associated with the resource 108, and the operational status indicator 306 associated with the resource 108. The data repository 110 may act as a main or master repository and the modification enabling framework 114 may act as a main branch. The virtual instance may thus be a new/separate version of the main branch. In other words, the virtual instance may be a branch or an extension drawn or derived from the main branch. The virtual instance may thus be an independent branch/line generated by the processor 104, from the main branch, for modification, development, and/or support-related activities. The virtual instance may be isolated from the main branch. Therefore, the virtual instance may enable the one or more developer-end entities 106 to perform maintenance, development, and/or support-related activities with respect to the resource 108. The virtual instance, or branches, may allow performance of such activities in a contained area of the data repository 110 associated with the main branch (i.e., the modification enabling framework 114). Thus, the maintenance, development, and/or support-related activities may be performed in isolation from the maintenance, development, and/or support-related activities that may be performed by other developer-end entities.

In one example, triggering of generation of the virtual instance may trigger rendering of a second graphical interface (not shown). For example, the second graphical interface may be rendered before generation of the virtual instance and after the processor 104 has ascertained that the resource 108 is to be engaged with the modification enabling framework 114. In one example, the second graphical interface may be rendered as a prompt after the processor 104 has ascertained that the resource 108 is to be engaged with the modification enabling framework 114. The second graphical interface may be a REACT-based interface and may be configured to receive instance data for being linked with the virtual instance. For example, the second graphical interface may include an area allowing the one or more developer-end entities 106 to enter textual information, such as the instance data. In one example, the instance data may include unique identification information enabling identification of the virtual instance. For example, the unique identification information may be a name with which the virtual instance is to be recognized and identified after generation.

In one example, the prompt or second graphical interface may further include at least one decision element. The processor 104 may trigger generation of the virtual instance based on occurrence of an interaction with the at least one decision element. For example, the decision element may be buttons that may indicate two options, such as “proceed” or “cancel”. In case the one or more developer-end entities 106 interacts (for example, clicks) with the “proceed” button, the processor 104 may proceed to trigger generation of the virtual instance. However, the one or more developer-end entities 106 interacts (for example, clicks) with the “cancel” button, the processor 104 may proceed to stop triggering generation of the virtual instance. In such a scenario, the processor 104 may again look forward to receiving any subsequent signal, such as the first signal.

Further, in one example, generation of the virtual instance may cause creation of a data file. The data file may record or save data related to the maintenance, development, and/or support-related activities performed by the one or more developer-end entities 106 while utilizing, engaging, and/or interacting with the virtual instance. In one example, the data file may include at least one of the executable content and the commit message. The executable content, in one example, may be a code written by the one or more developer-end entities 106 while performing the maintenance, development, and/or support-related activities by utilizing, engaging, and/or interacting with the virtual instance. In one example, the code may be written in python programming language. Further, the commit message, for example, may be comments, messages, tags, or other non-executable descriptors added by the one or more developer-end entities 106 while performing the maintenance, development, and/or support-related activities.

In one example, the data file may be created by the processor 104 based on the maintenance, development, and/or support-related activities performed by the one or more developer-end entities 106 by utilizing, engaging, and/or interacting with the virtual instance. In another example, the virtual instance may be configured to create the data file and share with the processor 104. The data file may be stored in the data repository 110. The data file, in one example, may be stored in the main repository, i.e., the data repository 110.

Further, the processor 104, or the interface generation module 308, may receive a second signal. In one example, the second signal may be received upon occurrence of a subsequent change in the operational status indicator 306. In one example, the operational status indicator 306 may subsequently be changed by the developer-end entities once the maintenance, development, and/or support-related activities, and thereby the data file, has at least been partially completed. The subsequent change in the operational status indicator 306 may thus indicate that creation of the data file has been at least partially completed. For example, once the maintenance, development, and/or support-related activities, and thereby the data file, has at least been partially completed, the one or more developer-end entities 106 may access the first graphical interface to update or change the operational status indicator 306 from “In development” to “In review”. Submission of the subsequently changed operational status indicator 306, by using the interactive component, may cause the generation and transmission of the second signal from the first graphical interface.

In response to receiving the second signal, the processor 104, or the resource analysis module 310 of the processor 104, may trigger parsing of at least one of the executable content and the commit message of the data file. Subsequently, the processor 104 may trigger generation of an updated specification. The updated specification may be generated for being associated with the resource 108. The updated specification may provide an updated overview of the resource 108 based on at least one of the executable content and the commit message of the data file. That is, the updated specification may provide an updated overview of the resource 108 based on the data file that recorded the maintenance, development, and/or support-related activities performed by the one or more developer-end entities 106 by accessing the virtual instance. In one example, the processor 104, or the resource analysis module 310, may perform parsing by a string of symbols, such as text or code, according to the rules of a formal grammar. The processor 104, or the resource analysis module 310, may breaking down the at least one of the executable content and the commit message of the data file into its individual elements and attempt to determine their structure and relationships using any known technique. In one example, during parsing, words, phrases, and clauses may be categorized, allowing the processor 104 to comprehend the meaning and intention behind the executable content and the commit message of the data file. For example, when parsing the datafile, the processor 104 may analyze its components to understand it better.

In another example, one example, the processor 104, or the resource analysis module 310 of the processor 104, may trigger an advanced learning model for parsing the executable content and the commit message of the data file and generating the updated specification. The advanced learning model may be a large language model (LLM) or may be capable of performing natural language processing (NLP). The advanced learning model may be communicably coupled with the processor 104, for example, through the communication network 112. The processor 104 may communicate with the advanced learning model to generate the updated specification. In another example, the advanced learning model may be a trained model and may be deployed on the processor 104.

Therefore, the processor 104, or the resource analysis module 310, may analyze and process at least one of the executable content and the commit message of the data file and accordingly generate the updated specification or overview based on the activities of the one or more developer-end entities 106. In one example, the updated specification may include at least one of an updated title and an updated description for the resource 108 based on the maintenance, development, and/or support-related activities performed by the developer-end entities. In one example, the updated specification may indicate a change over the specification that existed prior to performance of the maintenance, development, and/or support-related activities.

Once the updated specification has been generated, the processor 104 may generate a resource updation signal to associate the updated specification with the resource 108, thereby updating the resource 108. For example, in case the resource 108 is an enhancement proposal, the updated specification may include at least one of an updated title and an updated description. At least one of the updated title and the updated specification may indicate that the resource 108 (for example, the enhancement proposal) has been modified/updated. In another example, if the resource 108 is the computing resource, the updated specification may provide an updated overview of the computing resource. For example, the updated specification may include at least one of an updated title and an updated description indicating an update in operating parameters of the computing resource. In yet another example, if the resource 108 is the service itself, the updated specification may include at least one of an updated title and an updated description providing details about updated features associated with the service. In one example, the updated specification may be stored in the data repository 110.

In one example, the second signal may be indicative of a pull request. The processor 104, in response to receiving the pull request, may cause storing of the updated specification in the data repository 110. The pull request may thus cause merging of the updated specification, generated based on activities performed by interacting with the virtual instance (i.e., branch), with at least one of the main branch (i.e., the modification enabling framework 114) and the main repository (i.e., the data repository 110).

Thus, the system 102 may facilitate updating the specification of the resource 108 with a reduced number of switching operations between a plurality of tools and platforms.

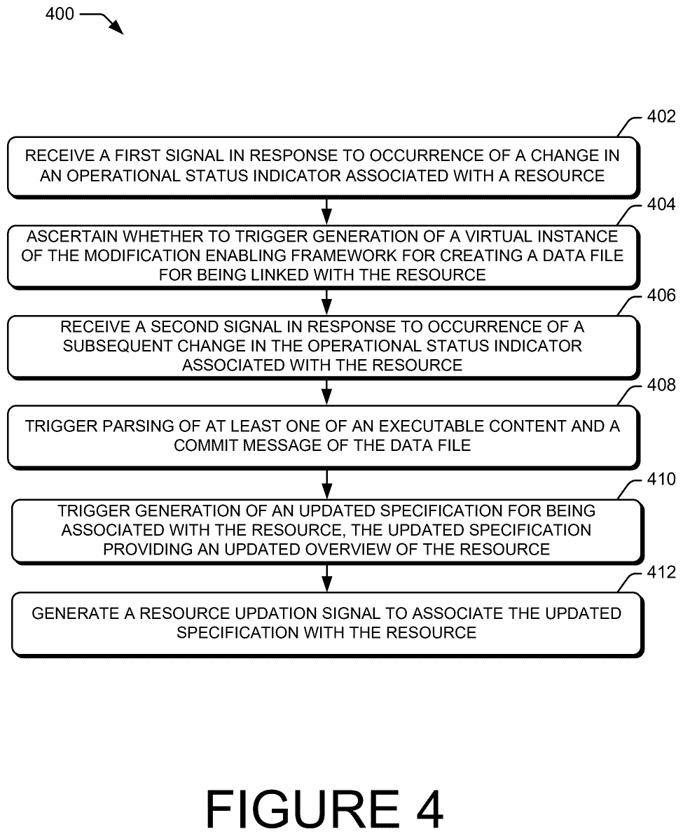

FIG. 4 illustrates a method 400 to update a resource, according to an example implementation of the present subject matter. In one example, updating the resource, such as the resource 108, may be implemented by updating at least one of the specification 304 and the operational status indicator 306 associated with the resource 108. In one example, the update or modification may be based on the maintenance, development, and/or support-related activities performed by the one or more developer-end entities 106.

The order in which the method is described is not intended to be construed as a limitation, and any number of the described method blocks may be combined in any order to implement the method, or an alternative method. Furthermore, the method 400 may be implemented by processing resource or computing device(s) through any suitable hardware, non-transitory machine-readable instructions, or combination thereof.

It may also be understood that method 400 may be performed by programmed computing devices, such as the system 102 or the processor 104, as depicted in FIG. 1A to FIG. 3. Furthermore, the method 400 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 400 is described below with reference to the processor 104 and the system 102 as described above, other suitable systems for the execution of these methods may also be utilized. Additionally, implementation of these methods is not limited to such examples.

At block 402, a first signal may be received in response to occurrence of a change in an operational status indicator associated with a resource. In one example, the resource may be the resource 108 and may have associated therewith the specification 304 providing an overview about the resource 108 and the operational status indicator indicating whether the resource is engaged with a modification enabling framework, such as the modification enabling framework 114. In one example, the resource may be engaged with the modification enabling framework to create a data file, such as the data file, for being linked with the resource.

In one example, the first signal may be indictive of a request for generating a virtual instance of the modification enabling framework. In one example, a first graphical interface, such as the first graphical interface discussed above with reference to FIG. 3, may be rendered. The first graphical interface may allow submission of a request for generating the virtual instance of the modification enabling framework. The request may be the first signal. In another example, the request may cause generation of the first signal.

In one example, the first signal may be generated in response to reception of the request through the first graphical interface. As discussed with reference to FIG. 3, the first graphical interface may indicate the interactive component. The interactive component may be, in one example, a submit button with which the one or more developer-end entities 106 may interact to submit the operation status indicator 306 or changed operation status indicator 306 for the resource 108. By interacting with the interactive component, the request to change the operation status indicator 306 may be submitted. The request may cause generation the first signal.

The first signal may thus be received upon occurrence of a change in the operational status indicator 306 associated with the resource. The operational status indicator 306 may be changed, in one example, to indicate that the resource is to be engaged with the modification enabling framework. For example, using the actionable component, as discussed above, the one or more developer-end entities 106 may select “In development” as the operational status indicator.

At block 404, it may be ascertained whether generation of the virtual instance of the modification enabling framework is to be triggered for creating a data file for being linked with the resource. In one example, the ascertaining may be based on the operational status indicator associated with the resource. For example, if it is ascertained that the operational status indicator 306 indicates “In development”, it is ascertained that the resource is to be engaged with the modification enabling framework. However, if it is ascertained that the operational status indicator 306 does not indicate “In development”, it is ascertained that the resource 108 is not to be engaged with the modification enabling framework 114. In such a scenario, receiving of any further signal, such as a subsequent first signal, may be awaited. Thus, based on the operational status indicator, generation of the virtual instance may be triggered. The virtual instance may be similar to the virtual instance as discussed above with reference to FIG. 3.

In one example, triggering of generation of the virtual instance may trigger rendering of a second graphical interface, such as the second graphical interface as discussed above with reference to FIG. 3. For example, the second graphical interface may be rendered before generation of the virtual instance and after it has been ascertained that the resource is to be engaged with the modification enabling framework. In one example, the second graphical interface may be a REACT-based interface and may be configured to receive instance data for being linked with the virtual instance. In one example, the instance data may include unique identification information enabling identification of the virtual instance. In one example, the second graphical interface may further include at least one decision element. Generation of the virtual instance may be triggered based on occurrence of an interaction with the at least one decision element, as discussed above with reference to FIG. 3.

Further, in one example, generation of the virtual instance may cause creation of a data file. The data file may record or save data related to the maintenance, development, and/or support-related activities performed by the developer-end entities while engaging with the virtual instance. In one example, the data file may include at least one of the executable content and the commit message. The executable content, in one example, may be a computer-readable instructions written by the one or more developer-end entities 106 while performing the maintenance, development, and/or support-related activities. Further, the commit message, for example, may be comments, messages, tags, or other non-executable descriptors added by the one or more developer-end entities 106 while performing the maintenance, development, and/or support-related activities.

At block 406, a second signal may be received in response to occurrence of a subsequent change in the operational status indicator associated with the resource. In one example, the operational status indicator 306 may subsequently be changed by the one or more developer-end entities once the maintenance, development, and/or support-related activities, and thereby the data file, has at least been partially completed. For example, the one or more developer-end entities may access the first graphical interface to update or change the operational status indicator from “In development” to “In review”. Submission of the subsequently changed operational status indicator may cause the generation and transmission of the second signal from the first graphical interface.

At block 408, parsing of at least one of an executable content and a commit message of the data file may be triggered.

At block 410, generation of an updated specification may be triggered for being associated with the resource, the updated specification providing an updated overview of the resource. In one example, the updated specification may provide an updated overview of the resource based on at least one of the executable content and the commit message of the data file. That is, the updated specification may provide an updated overview of the resource based on the data file that recorded the maintenance, development, and/or support-related activities performed by the one or more developer-end entities 106 by accessing the virtual instance.

In one example, for parsing at least one of the executable content and the commit message of the data file, and thereby generating the updated specification, the advanced learning model may be triggered. The advanced learning model may be a large language model (LLM) or may be capable of performing natural language processing (NLP). The advanced learning model may assist in generating the updated specification or overview. In one example, the updated specification may include at least one of an updated title and an updated description for the resource 108 based on the maintenance, development, and/or support-related activities performed by the one or more developer-end entities 106. In one example, the updated specification may indicate a change over the specification that existed prior to performance of the maintenance, development, and/or support-related activities. Thus, manual performance of administrative tasks, after performing the maintenance, development, and/or support-related activities, may not be required.

At block 412, a resource updation signal may be generated to associate the updated specification with the resource. In one example, once the updated specification has been generated, the resource updation signal may be generated to associate the updated specification with the resource, thereby updating the resource. Thus, the system 102 may assist the one or more developer-end entities in updating the specification of the resource 108 with a reduced number of switching operations.

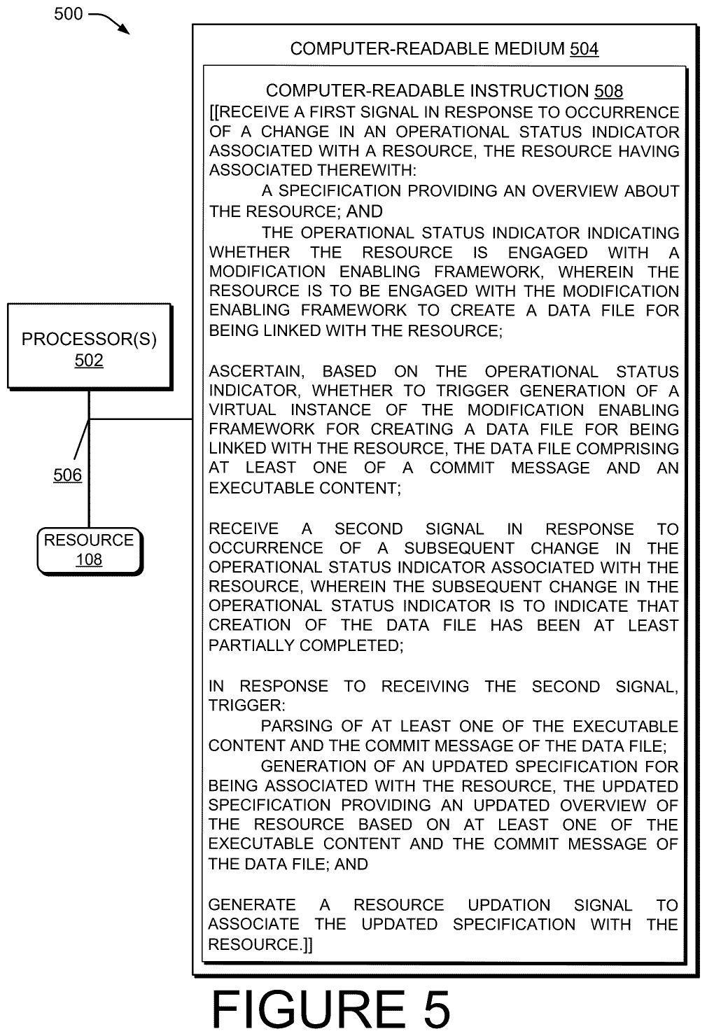

FIG. 5 illustrates a computing environment 500 implementing a non-transitory computer-readable medium for generating recommendations by identifying linkable items, according to an example implementation of the present subject matter. In one example, the computing environment 500 includes processor(s) 502 communicatively coupled to a non-transitory computer readable medium 504 through a communication link 506. In an example implementation, the computing environment 500 may be one of the computing environments 100 and 300. In an example, the processor(s) 502 may have one or more processing resources for fetching and executing computer-readable instructions from the non-transitory computer readable medium 504. The processor(s) 502 and the non-transitory computer readable medium 504 may be implemented, for example, in the processor 104 (as has been described in conjunction with the preceding figures).

The non-transitory computer readable medium 504 may be, for example, an internal memory device or an external memory device. In an example implementation, the communication link 506 may be a network communication link. The processor(s) 502 and the non-transitory computer readable medium 504 may also be communicatively coupled to a resource, such as the resource 108 over the communication link 506. In an example implementation, the non-transitory computer-readable medium 504 may include a set of computer-readable instructions 508 which may be accessed by the processor(s) 502 through the communication link 506.

Referring to FIG. 5, in an example, the non-transitory computer-readable medium 504 may include the computer-readable instructions 508 that may cause the processor(s) 502 to implement functionalities and/or operations, similar to the functionalities and/or operations performed by the processor 104 as has been described in conjunction with the preceding figures. Thus, the functionalities and/or operations have been incorporated herein as reference to the preceding figures and have not been repeated or reproduced for the sake of brevity.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

What is claimed is:

1. A system comprising:
a processor to:
receive a first signal in response to occurrence of a change in an operational status indicator associated with a resource, the resource having associated therewith:
a specification providing an overview about the resource; and
the operational status indicator indicating whether the resource is engaged with a modification enabling framework, wherein the resource is to be engaged with the modification enabling framework to create a data file for being linked with the resource;
ascertain, based on the operational status indicator, whether to trigger generation of a virtual instance of the modification enabling framework for creating a data file for being linked with the resource, the data file comprising at least one of a commit message and an executable content;
receive a second signal in response to occurrence of a subsequent change in the operational status indicator associated with the resource, wherein the subsequent change in the operational status indicator is to indicate that creation of the data file has been at least partially completed;
in response to receiving the second signal, trigger:
parsing of at least one of the executable content and the commit message of the data file;
generation of an updated specification for being associated with the resource, the updated specification providing an updated overview of the resource based on at least one of the executable content and the commit message of the data file; and
generate a resource updation signal to associate the updated specification with the resource.

2. The system of claim 1, wherein the processor is to render a first graphical interface, wherein the first graphical interface is to indicate at least one of:
the operational status indicator associated with the resource;
an actionable component allowing to change the operational status indicator; and
an interactive component enabling submission of the changed operational status indicator.

3. The system of claim 2, wherein submission of the changed operational status indicator through the interactive component is to cause generation and transmission of the first signal, and wherein submission of the subsequently changed operational status indicator through the interactive component is to cause generation and transmission of the second signal.

4. The system of claim 1, wherein the processor is to trigger rendering of a second graphical interface, wherein the second graphical interface is to receive instance data for being linked with the virtual instance.

5. The system of claim 4, wherein the instance data comprises unique identification information enabling identification of the virtual instance.

6. The system of claim 4, wherein the second graphical interface comprises at least one decision element, and wherein the processor is to trigger generation of the virtual instance based on occurrence of an interaction with the at least one decision element.

7. The system of claim 1, wherein the processor is to trigger an advanced learning model for the parsing of at least one of the executable content and the commit message of the data file and the generation of the updated specification.

8. The system of claim 7, wherein the advanced learning model is capable of performing natural language processing (NLP).

9. The system of claim 1, the system further comprising a data repository communicably coupled with the processor, wherein the data repository is to store the updated specification.

10. The system of claim 9, wherein the second signal is indicative of a pull request, wherein the processor, in response to receiving the second signal, is to cause storing of the updated specification in the data repository.

11. A method comprising:
receiving a first signal in response to occurrence of a change in an operational status indicator associated with a resource, the resource having associated therewith:
a specification providing an overview about the resource; and
the operational status indicator indicating whether the resource is engaged with a modification enabling framework, wherein the resource is to be engaged with the modification enabling framework to create a data file for being linked with the resource;
ascertaining, based on the operational status indicator, whether to trigger generation of a virtual instance of the modification enabling framework for creating a data file for being linked with the resource, the data file comprising at least one of a commit message and an executable content;
receiving a second signal in response to occurrence of a subsequent change in the operational status indicator associated with the resource, wherein the subsequent change in the operational status indicator is to indicate that creation of the data file has been at least partially completed;
in response to receiving the second signal, triggering:
parsing of at least one of the executable content and the commit message of the data file;
generation of an updated specification for being associated with the resource, the updated specification providing an updated overview of the resource based on at least one of the executable content and the commit message of the data file; and
generating a resource updation signal to associate the updated specification with the resource.

12. The method of claim 11, the method comprising rendering a first graphical interface to allow submission of a request for generating the virtual instance of the modification enabling framework, wherein the first signal is to be generated in response to reception of the request by the first graphical interface.

13. The method of claim 11, the method further comprising rendering a second graphical interface to receive instance data for being linked with the virtual instance, the instance data comprising unique identification information enabling identification of the virtual instance.

14. The method of claim 13, wherein the second graphical interface comprises at least one decision element, and wherein generation of the virtual instance is to be triggered based on occurrence of an interaction with the at least one decision element.

15. The method of claim 11, the method further comprising triggering an advanced learning model for the parsing of at least one of the executable content and the commit message of the data file and the generating of the updated specification.

16. The method of claim 15, wherein the advanced learning model is capable of performing natural language processing (NLP).

17. A non-transitory computer-readable medium comprising instructions being executable by a processing resource to:
receive a first signal in response to occurrence of a change in an operational status indicator associated with a resource, the resource having associated therewith:
a specification providing an overview about the resource; and
the operational status indicator indicating whether the resource is engaged with a modification enabling framework, wherein the resource is to be engaged with the modification enabling framework to create a data file for being linked with the resource;
ascertain, based on the operational status indicator, whether to trigger generation of a virtual instance of the modification enabling framework for creating a data file for being linked with the resource, the data file comprising at least one of a commit message and an executable content;
receive a second signal in response to occurrence of a subsequent change in the operational status indicator associated with the resource, wherein the subsequent change in the operational status indicator is to indicate that creation of the data file has been at least partially completed;
in response to receiving the second signal, trigger:
parsing of at least one of the executable content and the commit message of the data file;
generation of an updated specification for being associated with the resource, the updated specification providing an updated overview of the resource based on at least one of the executable content and the commit message of the data file; and
generate a resource updation signal to associate the updated specification with the resource.

18. The non-transitory computer-readable medium of claim 17, wherein the instructions are executed by the processing resource to cause triggering of an advanced learning model for the parsing of at least one of the executable content and the commit message of the data file and the generation of the updated specification.

19. The non-transitory computer-readable medium of claim 18, wherein the advanced learning model is capable of performing natural language processing (NLP).

20. The non-transitory computer-readable medium of claim 18, wherein the advanced learning model is a Large Language Model (LLM).
